(19) United States
(12) Patent Application Publication
(10) Pub. No.: US 2003/0141722 A1
(43) Pub. Date: Jul. 31, 2003

(54) Apparatus for latching a window

(76) Inventors: Ernest Mayo Smith, Sanford, FL (US); Terry Lee Adams, Gallatin, TN (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/354,586

(22) Filed: Jan. 31, 2003

Related U.S. Application Data
(60) Provisional application No. 60/353,202, filed on Jan. 31, 2002.

(51) Int. Cl. E05C 1/06

(52) U.S. Cl. 292/143

(57) ABSTRACT

An apparatus for securing a first article in stationary relationship to a second article where the first article and second article lie in offset planes when in a closed position. The apparatus may include a latch handle mounted in fixed relation to the first article with a plunger connected to the latch handle and responsive to movement of the latch handle. The latch handle may be articulated between a closed position and an open position such that the plunger is moved between a respective latched position and an unlatched position. A latching flange may be mounted in fixed relation to the second article such that the plunger engages a portion of the latching flange when the plunger is in the latched position to prevent the first article and the second article from moving in a lateral relation to each other. The first article and the second article may be prevented from moving in a substantially planar relation to each other when the first article and the second article are in a closed position.

### SPECIFIC DATA RELATED TO THE INVENTION

This application claims the benefit of U.S. provisional patent application, Application No. 60/353,202, filed Jan. 31, 2002, incorporated herein by reference.

### BACKGROUND OF THE INVENTION

The present invention relates to a center latch for a sliding glass window or door and in particular to a center latch used to preclude access through a sliding window or door on a vehicle.

The present invention is concerned with sliding glass windows or doors that are often used on off-highway vehicles, for example, such as large tractors or skid steer loaders. These vehicles typically have a fairly large sliding glass opening that can be used to either allow ingress or egress from the vehicle or may be merely a window to allow ventilation of the vehicle when in use. When the vehicles are not in use, it is desirable to provide a latch that maintains the window or door in a closed position and prevents a person from prying the windows or door sections apart at their overlapping position in order to open the sliding portion of the window or door.

### SUMMARY OF THE INVENTION

An apparatus for securing a first article in stationary relationship to a second article where the first article and second article lie in offset planes when in a closed position is provided. The apparatus may include a latch handle mounted in fixed relation to the first article with a plunger connected to the latch handle and responsive to movement of the latch handle latch handle may be articulated between a closed position and an open position such that the plunger is moved between a respective latched position and an unlatched position. A latching flange may be mounted in fixed relation to the second article such that the plunger engages a portion of the latching flange when the plunger is in the latched position to prevent the first article and the second article from moving in a lateral relation to each other. The first article and the second article may be prevented from moving in a substantially planar relation to each other when the first article and the second article are in a closed position.

One aspect allows for an apparatus for latching a first glass panel and a second glass panel in a closed position where the first and second panels form a rear window of a vehicle's cab and are disposed in sliding relation to each other. The latching apparatus may include a first track affixed to the first panel, the first track including a flange portion extending inward of the vehicle's cab. A second track may be affixed to the second panel, the second track comprising a latching flange extending inward of the vehicle's cab. A latch base may be connected in fixed relation to the flange portion of the first track, the latch base including a channel formed therein for receiving a first pin and an extension configured to extend beneath a recess formed in the latching flange when the first panel and second panel are in the closed position. A latch handle may be mounted for articulation about the first pin and a plunger may be connected to the latch handle, the plunger moveable between a latched position and an unlatched position in response to articulation of the latch handle.

Various exemplary embodiments of the present invention are advantageous in that they provide means for preventing a pair of sliding panels from moving in lateral relation to each other when in a closed position. They also provide means for preventing the panels from separating in a substantially planar relationship. For example, one exemplary embodiment may be used to latch a pair of glass panels that form a rear window in a vehicle's cab. When latched, aspects of the present invention prevent the windows from sliding laterally and one window from being pushed inward of the cab relative to the other. In this respect, the two panels are secured in a stationary relationship making it difficult to break into the vehicle's cab.

### BRIEF DESCRIPTION OF THE DRAWINGS

FIG. 1 is a cross-sectional view of an exemplary embodiment of the present invention shown in conjunction with a sliding window arrangement;

FIG. 2 is a perspective view of an exemplary embodiment of the present invention separated from the glass panels to which it may be mounted; and

FIG. 3 is an exploded view of the exemplary components of one embodiment of the present invention.

### DETAILED DESCRIPTION OF THE INVENTION

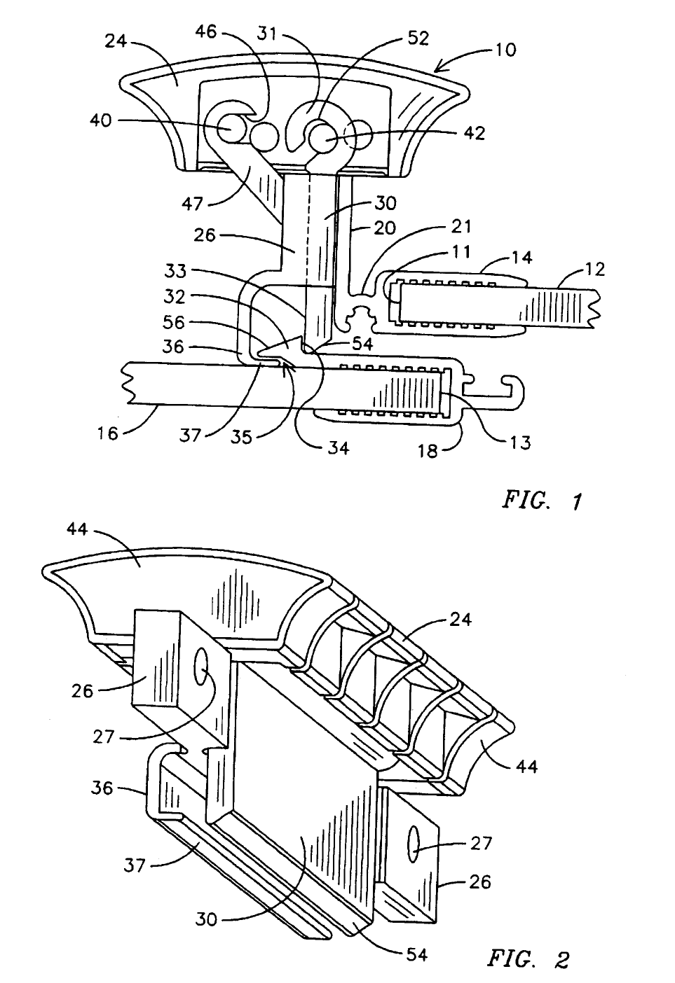

FIG. 1 is a cross-sectional view of an exemplary embodiment of an apparatus for latching 10, in a closed position, a sliding window arrangement such as that disposed in the rear portion of the cab of a construction vehicle, for example. It will be appreciated by those skilled in the art that the apparatus 10 may be adapted for latching in a closed position other two-unit closures where at least one moves opposite another provided each unit has a substantially planar surface area to which an embodiment of the present invention may be mounted. For example, embodiments of the present invention may be adapted for and mounted to structures or articles lying in offset vertical planes such as sliding glass doors, sliding wood panels or sliding aluminum garage doors. Further, aspects of the present invention may be adapted for use with a door mounted on a frame with springed hinges that allow the door to move away from the frame before opening. In this respect, the door is free to move slightly laterally prior to being swung open about its hinges.

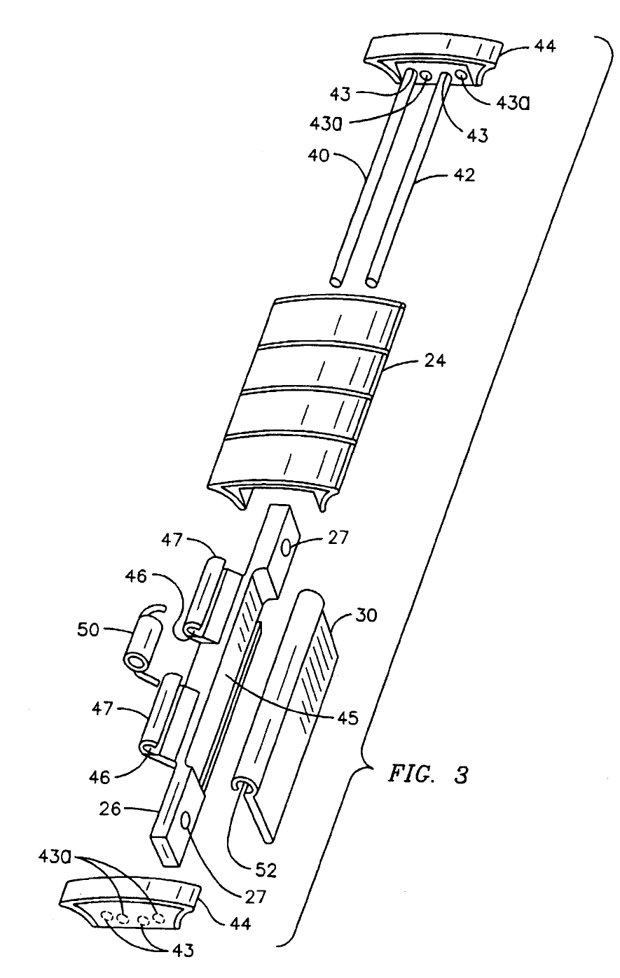

In the exemplary embodiment of FIG. 1, at least a portion of one edge 11 of an inner sliding glass panel 12 may be contained within a track 14 and at least a portion of a mating edge 13 of an outer glass panel 16 may be contained within a surrounding track 18. The inner glass panel 12 may be position on the inside side of a vehicle's cab relative and the outer glass panel 16 may be positioned on the outside side of the cab. Panel 16 may be stationary or fixed where panel 12 may slide horizontally to open and close the rear portion of the cab. Various embodiments of latching apparatus 10 may be adapted for use with panels that both slide between an open and closed position. Tracks 14 and 18 may surround the entire periphery of panels 12 and 16 or they may overlay only a portion of each respective panel sufficient for mounting apparatus 10. Tracks 14 and 18 may be extruded from a metal or metal alloy such as aluminum or other appropriate materials, for example. The track 14 may include a flange portion 20 that may extend inward of a vehicle's cab, for example, and is generally perpendicular to and attached to the track 14 via a bridge portion 21. The flange portion 20 may be sized to allow for attachment of the latching apparatus 10 as more fully discussed below. The latching apparatus 10 may include a grip portion or latch handle 24 that may be pivotally mounted to a support member or latch base 26. Latch base 26 may be attached to the flange 20 by conventional means such as by a nut and bolt inserted through respective apertures 27, best shown in FIGS. 2 and 3, and through corresponding apertures (not shown) in the flange portion 20. Alternate means for attaching the latch base 26 to the flange 20 will be recognized by those skilled in the art. The handle 24 may be pivotally mounted to latch base 26 about a first or latch pin 40. Latch pin 40 may be anchored at each end and pass through the latch handle 24, as more fully described below, so that when the handle 24 is articulated or rotated in a counterclockwise direction, for example, it lifts a latching plunger 30 in a substantially planar direction. Latching plunger 30 may be lifted to unlatch the slidable glass panel 12 and allow the panel to slide in a direction to overlap the stationary or fixed panel 16.

When the exemplary embodiment of apparatus 10 shown in FIG. 1 is in the latched position, the plunger 30 may extend into engagement with a latching flange 32 that may be formed integrally with the track 18. A lip 34 may be formed on the flange 32 that may abut against a portion of an inner edge 33 of the plunger 30 when apparatus 10 is in the latched position. This engagement prevents the plunger 30 from sliding laterally toward lip 34, or from right to left as shown in FIG. 1, and consequently prevents the glass panel 12 from being moved in the same lateral direction. One exemplary embodiment allows for the latching flange 32 of track 18 to include a portion that extends partially above the panel 16 to form a recessed area 35 beneath the latching flange 32. The latch base 26 may include a substantially arcuate arm or extension portion 36 having a distal end segment 37. When the exemplary embodiment of apparatus 10 is in the latched position as shown in FIG. 1, the distal end 37 may extend into the recessed area 35 formed beneath the latching flange 32. This configuration is advantageous in that it prevents panel 12 from being urged inwardly and away from panel 16 toward the inside of a vehicle's cab, for example. In this respect, panels 12 and 16 are prevented from being pried or pushed apart by inserting a tool between the tracks 14 and 18 such as might be done by someone attempting to break into a vehicle's cab. The exemplary embodiment of FIG. 1 provides the advantage of simultaneously preventing the panels 12 and 16 and/or the tracks 14 and 18 from being pried apart while the plunger 30 prevents the panel 12 from being moved laterally into its open position.

FIG. 2 illustrates a perspective view of an exemplary embodiment of latching apparatus 10 in a latching position but separated from the panels 12 and 16 and the tracks 14 and 18 shown in FIG. 1. Referring to FIG. 3, one aspect allows for providing a means for articulating latch handle 24, such as a first pin 40 disposed between end caps 44, to withdraw the plunger 30 away from the latching flange 32. A proximal end 31 of plunger 30 may be connected to a second pin 42 so that the plunger 30 is responsive to movement of the latch handle 24. A slot 45 may be formed in the latch base 26 for guiding the plunger 30 in a plane that is substantially perpendicular to the panel 16. When the plunger 30 is withdrawn above the latching flange 32 the panel 12 may be moved laterally toward an open position. The first and second pins 40 and 42 may be anchored at one end in a first set of respective apertures 43 located in a latch handle end cap 44. The pins 40 and 42 may extend through the latch handle 24 and be anchored at their other end in respective apertures 43 located in an opposing latch handle end cap 44. End caps 44 may be manufactured from the same molding process, for example, having an identical set of apertures 43 and 43a so that any end cap 44 may be used for anchoring pins 40 and 42 at either end of handle 24. Manufacturing end caps 44 that are interchangeable instead of customized for one end may significantly reduce manufacturing costs and allows for easier assembly of embodiments of the latching apparatus 10. Apertures 43 may be formed in respective end caps 44 so that when the end caps 44 are affixed with the handle 24 the pair of pins 40 and 42 are substantially parallel to each other. Referencing FIG. 1, one aspect allows for apertures 43 to be vertically offset in end cap 44 so that pin 40 resides in a horizontal plane that is slightly higher than a horizontal plane within which pin 42 resides when pins 40 and 42 are anchored between respective end caps 44. One aspect allows for apertures 43 to be horizontally offset from a vertical or longitudinal centerline of latch handle 24 to create leverage for rotating latch handle 24 about pin 40 in a counterclockwise direction so that plunger 30 may be withdrawn from lip 34. In this respect, pin 42 is closer to the latch handle's 24 vertical centerline than is pin 40. The pin 40 may extend through a pair of substantially circular channels 46 where each may be formed as part of a respective pair of extensions 47 disposed in spaced relation on the latch base 26. A means for biasing the latch handle 26 toward a latched position may be provided such as a coil spring 50 that may inserted on pin 40 and disposed between the two spaced extensions 47. The means for biasing may maintain the latch handle 26 in its normally latched position and urge the handle 24 toward the latched position after a user has rotated handle 24 in a counterclockwise direction. Alternate means for biasing will be recognized by those skilled in the art.

The plunger 30 may be connected with the latch handle 24 by inserting the pin 42 through a substantially circular channel 52 that may be formed longitudinally as part of an upper edge of the plunger 30. The latch handle 24 may be affixed by conventional means to end caps 44 such as by bonded handle 24 to each of the end caps 44 by adhesive or other well-known means. The latch handle 24 provides a griping area and a protective cover that may also be aesthetically appealing. The plunger 30 may include a beveled surface portion 54 that may engage a corresponding beveled surface portion 56 of the latching flange 32 as best shown in FIG. 1. For example, when panel 12 is in an open position the plunger 30 will be on the opposite side of latching flange 32 than that shown in FIG. 1. In this respect, if an end user decides to slide the panel 12 to the right, as viewed from FIG. 1, to move panel 12 to a closed position then the beveled surface 54 is adapted to engage the beveled surface 56 to urge the plunger 30 away from panel 16. Surface 54 may ride along surface 56 until the plunger 30 passes lip 34 in which event the biasing means will urge the plunger 30 toward panel 16 and the apparatus 10 will be in its latching position. The interaction of surfaces 54 and 56 are advantageous in that it allows an end user to slide panel 12 to its closed position without the need for affirmatively rotating handle 24 counterclockwise with one hand, for example. An end user may conveniently move panel 12 to its closed position without the need for specifically gripping the latching apparatus 10 by just pushing or pulling directly on panel 12.

It will be appreciated by those skilled in the art that various components of the present invention may be molded of lightweight, durable composite material such as black Derlin®, for example.

While the exemplary embodiments of the present invention have been shown and described by way of example only, numerous variations, changes and substitutions will occur to those of skill in the art without departing from the invention herein. Accordingly, it is intended that the invention be limited only by the spirit and scope of the appended claims.

We claim:

1) An apparatus for securing a first article in stationary relationship to a second article where the first article and second article lie in offset planes when in a closed position, the apparatus comprising:
a latch handle mounted in fixed relation to the first article;
a plunger connected to the latch handle and responsive to movement of the latch handle;
means for articulating the latch handle between a closed position and an open position such that the plunger is moved between a respective latched position and an unlatched position;
a latching flange mounted in fixed relation to the second article such that the plunger engages a portion of the latching flange when the plunger is in the latched position to prevent the first article and the second article from moving in a lateral relation to each other; and
means for preventing the first article and the second article from moving in a substantially planar relation to each other when the first article and the second article are in a closed position.

2) The apparatus of claim 1 further comprising:
means for biasing the latch handle toward the closed position.

3) The apparatus of claim 1, the means for articulating the latch handle comprising:
a first pin mounted between a first end cap and a second end cap, the first and second end caps being affixed to a respective first end and a respective second end of the latch handle;
a latch base mounted in fixed relation to the first article; and
a channel formed within the latch base to receive the first pin so that the latch handle may be articulated about the first pin to move the latch handle between the closed position and the open position.

4) The apparatus of claim 3 further comprising:
a second pin mounted between the first end cap and the second end cap such that the first pin and the second pin are in substantially parallel spaced relation and wherein a proximal end of the plunger is connected to the second pin; and
a slot formed within the latch base for guiding the plunger in a plane substantially perpendicular to the second article when the latch handle is articulated about the first pin.

5) The apparatus of claim 4 wherein the first pin defines a plane that is offset from a plane defined by the second pin.

6) The apparatus of claim 4 wherein the second pin is closer to a longitudinal centerline of the latch handle than the first pin.

7) The apparatus of claim 1, the means for preventing the first article and the second article from moving in a substantially planar relation to each other when the first article and the second article are in the closed position comprising:
a recess formed between a portion of the latching flange and the second article; and
a substantially arcuate arm mounted in fixed relation to the first article such that a distal end of the arcuate arm fits within the recess to engage a portion of the latching flange to prevent the first and second articles from moving in planar relation to each other.

8) The apparatus of claim 1 further comprising:
a first track affixed to the first article;
a flange portion integral with the first track and extending substantially perpendicularly from the first article;
a latch base connected to the flange portion; and
the means for articulating the latch handle comprising a first pin mounted between a first end cap and a second end cap, the first and second end caps being affixed to a respective first end and a respective second end of the latch handle and a channel formed within the latch base to receive the first pin so that the latch handle may be articulated about the first pin to move the latch handle between the closed position and the open position.

9) The apparatus of claim 8 further comprising:
a second track affixed to the second article where the latching flange is integral with the second track.

10) The apparatus of claim 9 wherein the first track covers the perimeter of the first article and the second track covers the perimeter of the second article.

11) The apparatus of claim 8 further comprising:
means for biasing the latch handle toward the closed position.

12) An apparatus for latching a first glass panel and a second glass panel in a closed position where the first and second panels form a rear window of a vehicle's cab and are disposed in sliding relation to each other, the apparatus comprising:
a first track affixed to the first panel, the first track comprising a flange portion extending inward of the vehicle's cab;
a second track affixed to the second panel, the second track comprising a latching flange extending inward of the vehicle's cab;
a latch base connected in fixed relation to the flange portion of the first track, the latch base comprising a channel formed therein for receiving a first pin; and an extension configured to extend beneath a recess formed in the latching flange when the first panel and second panel are in the closed position;
a latch handle mounted for articulation about the first pin; and
a plunger connected to the latch handle, the plunger moveable between a latched position and an unlatched position in response to articulation of the latch handle.

13) The apparatus of claim 12 further comprising:
a slot formed in the latch base for guiding the plunger in a plane that is substantially perpendicular to a planar surface of the second panel.

14) The apparatus of claim 12 further comprising:
a lip formed on the latching flange configured to abut a distal end of the plunger when the plunger is in the latched position so that the first panel and the second panel may not be moved laterally toward each other.

15) The apparatus of claim 12 further comprising:
a first beveled surface formed on a distal end of the plunger; and
a second beveled surface formed on the latching flange where the first beveled surface is configured to engage the second beveled surface and urge the plunger away from the second track when the first panel is slid past the latching flange into the closed position.

16) The apparatus of claim 12 further comprising:
a first end cap affixed to a first end of the latch handle;
a second end cap affixed to a second end of the latch handle such that the first pin is disposed there between; and
a second pin disposed between the first end cap and the second end cap for connecting the plunger to the latch handle.

17) The apparatus of claim 16 where the first pin and the second pin are in substantially parallel spaced relation and the first pin defines a plane that is offset from a plane defined by the second pin.

18) The apparatus of claim 17 further comprising:
a coil spring disposed on the first pin for biasing the latch handle toward a closed position.
